(19) United States
(12) Patent Application Publication
(10) Pub. No.: US 2010/0201514 A1
(43) Pub. Date: Aug. 12, 2010

(54) REMOTE MONITORING SYSTEM

(75) Inventors: Anthony F. Barna, North Massapequa, NY (US); A. Arthur Kressner, Westfield, NJ (US); Lawrence P. Nardo, Brooklyn, NY (US); Charles W. Melvin, JR., Dudley, GA (US); Jason P. Walton, Byron, GA (US)

Correspondence Address: CANTOR COLBURN, LLP, 20 Church Street, 22nd Floor, Hartford, CT, 06103, US

(73) Assignees: CONSOLIDATED EDISON COMPANY OF NEW YORK, INC., New York, NY (US); SMARTSYNCH, INCORPORATED, Jackson, MS (US)

(21) Appl. No.: 12/624,089

(22) Filed: Nov. 23, 2009

Related U.S. Application Data
(60) Provisional application No. 61/151,289, filed on Feb. 10, 2009.

(51) Int. Cl. G08B 1/08

(52) U.S. Cl. 340/539.22

(57) ABSTRACT

A monitoring system is provided that allows for monitoring and reporting of operational parameters for processes and devices in a subterranean environment. The system includes a plurality of interface devices coupled to sensors at a desired process or device. The interface devices transmit the measured data to a coordinator device through a personal area network. The coordinator device aggregates data from multiple interface devices and transmits the data to a remote service through a communications network.

### CROSS REFERENCE TO RELATED APPLICATION

This application is a non-provisional application of U.S. Provisional Patent Application 61/151,289 entitled “REMOTE MONITORING SYSTEM,” filed Feb. 10, 2009 and which is incorporated herein in its entirety.

### BACKGROUND OF THE INVENTION

The present invention relates generally to a system for remotely monitoring parameters and more particularly to a system that provides for the remote monitoring and communication of utility parameters in a redundant and reliable manner.

A public utility is an organization that provides a commodity needed by the general public. Public utilities provide a number of different commodities, such as electricity, telecommunications, water, steam and natural gas for example. The public utility maintains an infrastructure that allows delivery of the commodity and is often subject to governmental regulations that require certain levels of reliability. The commodity infrastructure may take a number of different forms; electrical wires carry electricity and telecommunications, while pipes carry steam, water and natural gas.

Government regulations require that public utilities maintain high levels of reliability. In response to this, the public utilities have developed processes and procedures to monitor the operation and performance of their infrastructure systems. Such processes and procedures may require utility personnel to periodically visit and inspect key junctions of the infrastructure. Alternatively, sensors may be installed to monitor desired parameters that are considered important to the proper operation of the systems. The sensors also provide an advantage in that large geographic areas can be monitored from a central control station. This allows for a faster and more coordinated response in the event an abnormal condition arises.

In large metropolitan areas, the components that make up the infrastructure are often installed underground. This keeps the infrastructure components out of the way of construction and another activities that take place in a busy urban environment. While the subterranean installations of the utility infrastructure may be convenient from an aesthetic point of view, it does create issues relative the monitoring of the infrastructure components. These underground components are harder to visually inspect, requiring personnel to travel into a manhole, a tunnel, or an excavated hole for example. The subterranean installation also makes it harder to utilize electronic sensors since the installation of cabling is cost prohibitive. The use of wireless technology for communications is hampered by interference from the ground and buildings.

The use of subterranean facilities is only expected to increase as the number of very large metropolitan cities increase. In 1950, there was one city, New York, with a population of over ten million people. Presently there are over twenty-five cities worldwide with this level of population. As the world-population continues to increase, the number of such megacities will only continue to increase. As the infrastructures of these cities are built to handle these increases in population, a larger amount of public utility services will be placed underground.

Thus, while existing remote monitoring systems are suitable for their intended purposes, there remains a need for improvements. In particular, there remains a need for improvements in providing remote monitoring of infrastructure components located in subterranean environments.

### SUMMARY OF THE INVENTION

A monitoring system for measurement of parameters is provided. The monitoring system includes a first sensor. A first interface is directly coupled to the first sensor, the first interface adapted to wirelessly transmit a first input signal in response to receiving a signal from the first sensor. A second sensor is positioned in a geographically distinct position from the first sensor. A second interface is directly coupled to the second sensor, the second sensor adapted to wirelessly transmit a second input signal in response to receiving a signal from the second sensor. A third interface is coupled for wirelessly communicating with the first interface and the second interface, wherein the first interface, the second interface and the third interface form a wireless personal area network. A communications device is directly coupled to the third interface, the communications device is adapted to transmit an output signal to a remote server in response to the third interface receiving the first input signal or the second input signal.

A monitoring system for subterranean devices is also provided. The monitoring system includes a first sensor adapted to sense a presence and quantity of a first parameter associated with the subterranean devices. An interface in communication with the sensor, the interface adapted to convert sensor signals received from the first sensor into a first output signal. A coordinator in wireless communication with the interface, the coordinator adapted to transmit a second output signal through a communications network in response to receiving the first output signal. A remote server is coupled for communication to the coordinator by the communications network, wherein the remote server is adapted to receive and store the second output signal.

Another monitoring system for a subterranean utility system is also provided. The monitoring system includes a first plurality of sensors, each of the first plurality of sensors adapted to monitor parameters associated with the utility system. A first plurality of interfaces, each of the first plurality of interfaces being associated with one of the first plurality of sensors, wherein each of the first plurality of interfaces includes a processor that hosts a web server configured to transmit a first input signal in response to receiving a signal from the associated sensor. A first coordinator arranged to be wirelessly coupled for communication to the web servers associated with the first plurality of interfaces, the first coordinator being adapted to receive input signals from the web servers and transmit an first output signal in response to receiving the first input signals, wherein the first coordinator and the first plurality of sensors form a first personal area network.

### BRIEF DESCRIPTION OF THE DRAWINGS

Referring now to the drawings, which are meant to be exemplary and not limiting, and wherein like elements are numbered alike:

FIG. 1 is a schematic illustration of a monitoring system in accordance with an embodiment of the invention;

FIG. 2 is a schematic illustration of a monitoring system in accordance with another embodiment of the invention;

FIG. 3 is a schematic illustration of the interface device of FIG. 1;

FIG. 4 is schematic illustration of monitoring system of FIG. 1 used in monitoring electrical power distribution systems;

FIG. 5 is a schematic illustration of monitoring system of FIG. 4 for monitoring multiple feeder circuits in a subterranean environment; and,

FIG. 6 is a schematic illustration of the monitoring system of FIG. 1 used to monitor parameters of a steam trap in a district heating system.

### DETAILED DESCRIPTION

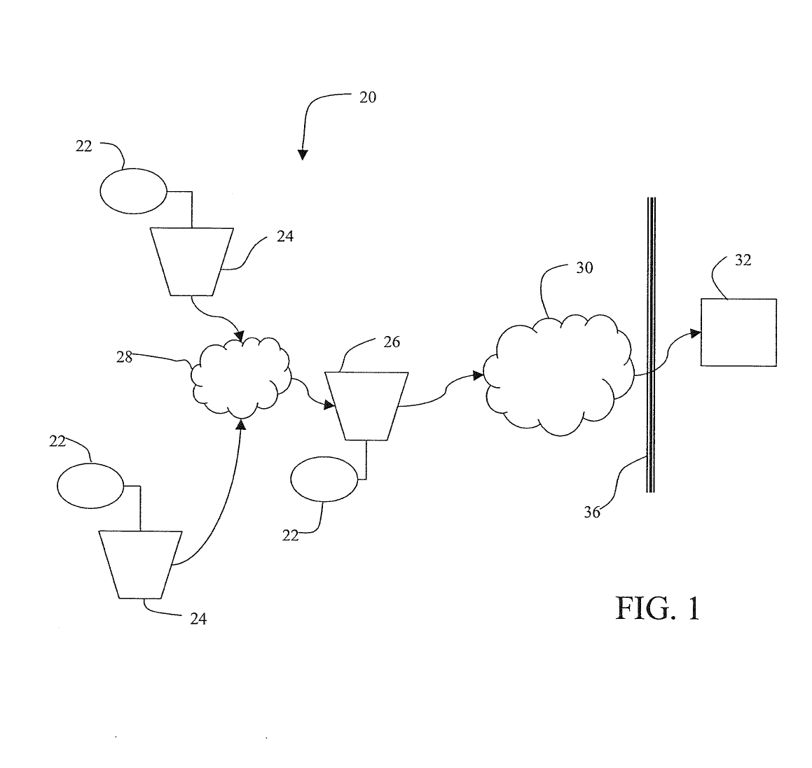

FIG. 1 illustrates an exemplary embodiment of a monitoring system 20. Monitoring systems 20 may be used in a wide variety of applications where parameters of a process, such as in the delivery of a goods or services, are remotely measured and the data transmitted to a central location for processing and analysis. In one embodiment, the process being measured is a public utility infrastructure that delivers a service, such as electricity, water, steam, petrochemicals or natural gas for example, to an end customer.

The monitoring system 20 includes sensors 22 that are arranged to measure one or more desired parameters. As will be discussed in more detail below, these sensors 22 include but are not limited to thermocouples, level sensors, pressure transducers, and current transformers for example. The sensors 22 are each directly coupled to an interface device 24. The interface device 24 receives signals from the sensors 22 and may also process the signal, such as converting a voltage into a standard unit of measurement for the parameter. The interface devices 24 may also include measurement hardware such as a meter with a display that allows a visible inspection of the data being collected. The interface devices 24 are arranged to communicate with a coordinator device 26 via a communications medium 28. In some embodiments, the coordinator device 26 is also coupled to a sensor 22. In other embodiments, the coordinator device 26 is identical to the interface device 24, but with additional communications capabilities.

In the exemplary embodiment, the interface devices 24 and the coordinator device 26 are positioned in a subterranean environment, such as a basement or an underground vault that is used for servicing and maintaining utility infrastructure components. These environments are typically small and have a large number of cables, conduits or pipes that provide the services being delivered. Therefore, in the exemplary embodiment, the communications medium 28 is an ad hoc personal area network capable of transmitting data without the installation of additional communications cabling. As such, the personal area network may be wireless mesh network defined by IEEE 802.15.4 protocol for example. The wireless mesh network provides a low cost, low speed communications network between devices, such as interface device 24 for example, that located in a proximate, though not necessarily close, to each other. Under the IEEE 802.15.4 protocol, the devices are generally within 10 meters of the coordinating device. Other types of communications protocols may also be used, such as the Bluetooth protocol, the wireless universal serial bus (USB) protocol, or the ultrawide band (UWB) protocol.

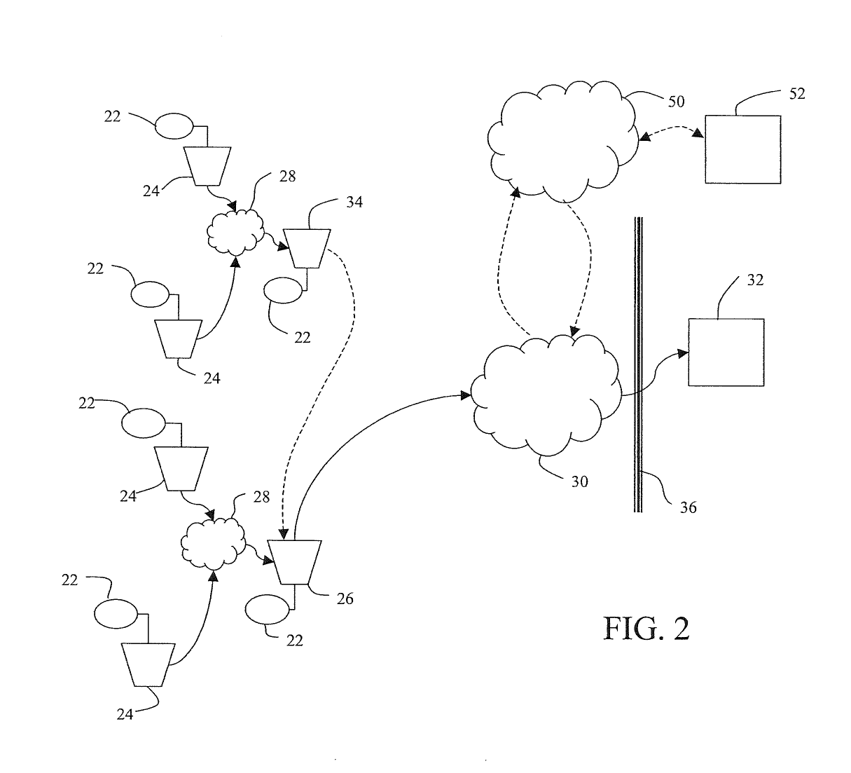

The coordinator device 26 receives data from the interface devices 24. This data is aggregated and either periodically or continuously transmitted via communications network 30 to a remote server 32. The communications network 30 may be any type of known network including, but not limited to, a wide area network (WAN), a public switched telephone network (PSTN) a local area network (LAN), a global network (e.g. Internet), a virtual private network (VPN), and an intranet. In the exemplary embodiment, the communications network 30 is implemented using a wireless network such as a cellular network, or a radio network. It should be appreciated that the communications network 30 may be any kind of physical network implementation known in the art. The coordinator devices 26 may be coupled to the remote server 32 through multiple networks (e.g., intranet and Internet). Further, the communications network 30 may also connect the coordinator device 26 to other devices such as coordinator device 34 illustrated in FIG. 2 for example. In this embodiment, the coordinator device 26 aggregates data from multiple personal area networks and transmits the aggregated data to the remote server 32.

The remote server 32 depicted in FIG. 1 and FIG. 2 may be implemented using one or more servers operating in response to a computer program stored in a storage medium accessible by the remote server 32. The remote server 32 may operate as a network server (e.g., a web server) to communicate with the coordinator devices 26, 34 and interface devices 24. The remote server 32 handles sending and receiving information to and from the coordinator devices 26, 34 and can perform associated tasks. The remote server 32 may also include firewalls 36 to prevent unauthorized access and enforce any limitations on authorized access. For instance, an administrator may have access to the entire system and have authority to modify portions of the system. A firewall 36 may be implemented using conventional hardware and/or software as is known in the art. It should be appreciated that additional computers or servers (not shown) may be coupled to communicate with the remote server 32.

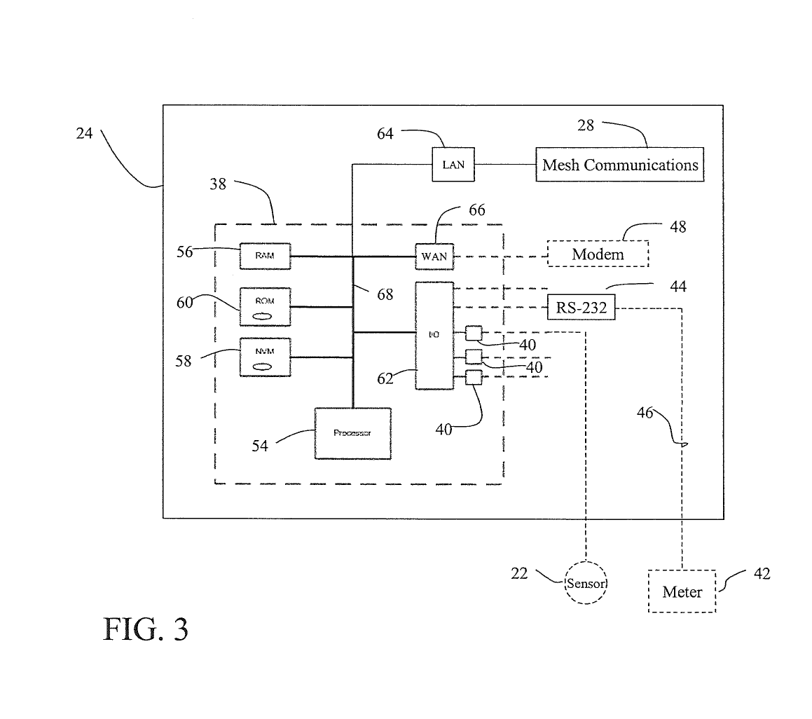

An exemplary embodiment of the interface device 24 is illustrated in FIG. 3. The sensor 22 is electrically coupled to a controller 38 in the interface device 24. Controller 38 is a suitable electronic device capable of accepting data and instructions, executing the instructions to process the data, and presenting the results. Controller 38 may accept instructions through user interface, or through other means such as but not limited to electronic data card, voice activation means, manually operable selection and control means, radiated wavelength and electronic or electrical transfer. Therefore, controller 38 can be a microprocessor, microcomputer, a minicomputer, an optical computer, a board computer, a complex instruction set computer, an ASIC (application specific integrated circuit), a reduced instruction set computer, an analog computer, a digital computer, a molecular computer, a quantum computer, a cellular computer, a superconducting computer, a supercomputer, a solid-state computer, a single-board computer, a buffered computer, a computer network, a desktop computer, a laptop computer, or a hybrid of any of the foregoing.

Controller 38 is capable of converting the analog voltage or current level provided by sensor 22 into a digital signal indicative of the desired parameter that the operator wishes to monitor. Alternatively, sensor 22 may be configured to provide a digital signal to controller 38, or an analog-to-digital (A/D) converter 40 maybe coupled between sensor 22 and controller 38 to convert the analog signal provided by sensor 22 into a digital signal for processing by controller 38. In one embodiment, digital signals are received from an external measurement device 42, such as an electrical meter 42 via an RS-232 serial communications port 44. Controller 38 uses the digital signals to act as input for various processes that control the interface device 24 and coordinator 26. The digital signals represent one or more system 20 data including but not limited to current levels, voltage, pressure levels, temperature, water levels, and the like.

Controller 38 may be operably coupled with one or more external measurement devices 42 by data transmission media 46. Data transmission media 46 includes, but is not limited to, twisted pair wiring, coaxial cable, and fiber optic cable. Data transmission media 46 also includes, but is not limited to, wireless, radio and infrared signal transmission systems.

In general, controller 38 accepts data from sensor 22 or external measurement device 42 and is given certain instructions for the purpose of comparing the data from sensor 22 or external measurement device 42 to predetermined operational parameters. Controller 38 may also provide operating signals to sensor 22 or external measurement device 42. Controller 38 further accepts data from sensor 22, indicating, for example, whether the temperature of a section of a steam trap has exceeded predetermined thresholds. The controller 38 compares the operational parameters to predetermined variances (e.g. low flow rate, low pressure, high pressure, high temperature) and if the predetermined variance is exceeded, generates a signal that may be used to indicate an alarm to an operator or the remote server 32. In one embodiment, the measured parameter data is transmitted to the remote server 32 on a continuous or interval basis. In another embodiment, the data is transmitted on an exception basis when an undesired, or unanticipated condition occurs. Additionally, the signal may initiate other control methods that adapt the operation of the system monitored such as changing the operational state of a valve (not shown) to compensate for the out of variance operating parameter.

In addition to being coupled to the sensors 22 or external devices 42 within system 20, controller 38 may also be coupled to other interface devices 24 or coordinator devices 26 through an ad hoc local or personal area network 28. As discussed above, the personal area network 28 interconnects the interface devices 24 with a coordinator device 26. In one embodiment, this network is a mesh network where multiple coordinator devices 26, 34 are interconnected to form a second layer of the mesh network. In one embodiment, the interface device 24 and the coordinator device 26, 34 are identical, with the coordinator device 26, 34 including an additional communications circuit, such as a cellular modem for example, that allows the coordinator device to communicate through a wide-area-network, such as communications network 30 or the Internet 50 for example. The modem 48 allows the controller 38 to communicate with the remote server 32 using a well-known computer communications protocol such as TCP/IP (Transmission Control Protocol/Internet Protocol), RS-232, ModBus, and the like. Additional systems 20 may also be connected to communications network 30 with the controllers 38 in each of these systems 20 being configured to send and receive data to and from remote servers 32 and other systems 20. Communications network 30 may be connected to the Internet 50. This connection allows controller 38 to communicate with one or more remote computers 52 connected to the Internet 50. In the embodiment where the system 20 is being used to monitor utility parameters, the remote computers 52 may be service providers to the utility for scheduling maintenance, billing or other activities for example.

Controller 38 includes a processor 54 coupled to a random access memory (RAM) device 56, a non-volatile memory (NVM) device 58, a read-only memory (ROM) device 60, one or more input/output (I/O) controllers 62, a LAN interface device 64 and a WAN interface device 66 via a data communications bus 68.

I/O controllers 62 are coupled to the sensors 22 and/or external devices 42, and alternatively to a user interface for providing digital data between these devices and bus 68. I/O controllers 62 may also be coupled to analog-to-digital (A/D) converters 40, which receive analog data signals from sensor 22. LAN interface device 64 provides for communication between controller 38 and the personal area network 28 in a data communications protocol supported by network 28. Similarly, the WAN interface device 66 provides for communications between the controller 38 and the communications network 30 in a data communications protocol supported by network 28. It should be appreciated that the protocols used by personal area network 28 and the communications network 30 may be the same or different.

ROM device 60 stores an application code, e.g., main functionality firmware, including initializing parameters, and boot code, for processor 54. Application code also includes program instructions for causing processor 54 to execute operation control methods, including the transmission of data and the generation of alarms. The application code creates a communications system may be used to transmit operating information between the system 20 and the remote server 32.

NVM device 58 is any form of non-volatile memory such as an EPROM (Erasable Programmable Read Only Memory) chip, flash memory, magnetic media, optical media, a disk drive, or the like. Stored in NVM device 58 are various operational parameters for the application code. The various operational parameters can be input to NVM device 58 either locally, using a keypad (not shown) or remote server 32, or remotely via the Internet 50 using remote computer 52. It will be recognized that application code can be stored in NVM device 58 rather than ROM device 60. The NVM device 58 may also be used to store data in the event the interface device 24 or coordinator device 26 loses communication with the coordinator device 26 or remote server 32 respectively. In the exemplary embodiment, the NVM device 58 may be able to store from one to three days of data. In one embodiment, the NVM device 58 provides up to 200K of data storage. It should be appreciated that such data storage may also be provided by RAM device 56.

Controller 38 includes operation control methods embodied in application code. These methods are embodied in computer instructions written to be executed by processor 54, typically in the form of software. The software can be encoded in any language, including, but not limited to, assembly language, VHDL (Verilog Hardware Description Language), VHSIC HDL (Very High Speed IC Hardware Description Language), Fortran (formula translation), C, C++, Visual C++, Java, ALGOL (algorithmic language), BASIC (beginners all-purpose symbolic instruction code), visual BASIC, ActiveX, HTML (HyperText Markup Language), and any combination or derivative of at least one of the foregoing. Additionally, an operator can use an existing software application such as a spreadsheet or database and correlate various cells with the variables enumerated in the algorithms. Furthermore, the software can be independent of other software or dependent upon other software, such as in the form of integrated software.

In some embodiments, the controller 38 includes operational control methods that include an embedded web server. Each controller 38 in each interface device 24 or coordinator device 26 has an embedded web server and its own separate IP address. Therefore, in order for the devices 24, 26, 34 to communicate with each other, or with the remote server 32 or with remote computer 52, the only requirement is that the devices IP address is known. A web browser can then be used as a command interface with the devices 24, 26, 34. This interface can be used to call remote application programming interface (API) on the interface device 24 or coordinator device 26, 34. Remote API are stored program routines that already exist on the interface device 24 and coordinator device 26, 34. Another option is to download user code that calls the remote API. This could be in the form of script to be interpreted by the controller 38. One option for calling remote API from the web browser is to use Simple Object Access Protocol (SOAP) Remote Procedure Calls (RPC) utilizing the HTTP 1.1 protocol. The RPC are in XML format and parsed by an XML parser on the embedded web server.

The web browser may also runs Java Applets, ActiveX controls, and Java Scripts (JScript) served up by controller 38. Java Applets and Active X controls can be used for monitoring real-time data, and Jscripts are used in many situations. Again, the controller 38 may serve up this code and the only requirement on the remote server 32 or remote computer 52 is to have a web browser.

In the embodiment where the controller 38 includes an embedded web server, the protocol for communications between the remote server 32 and the controller 38 is Hypertext Transfer Protocol (HTTP) over which web content is served, and TCP sockets over which data is transferred during real-time data monitoring and RPCs. On the controller 38, there may further be a File Transfer Protocol (FTP) server.

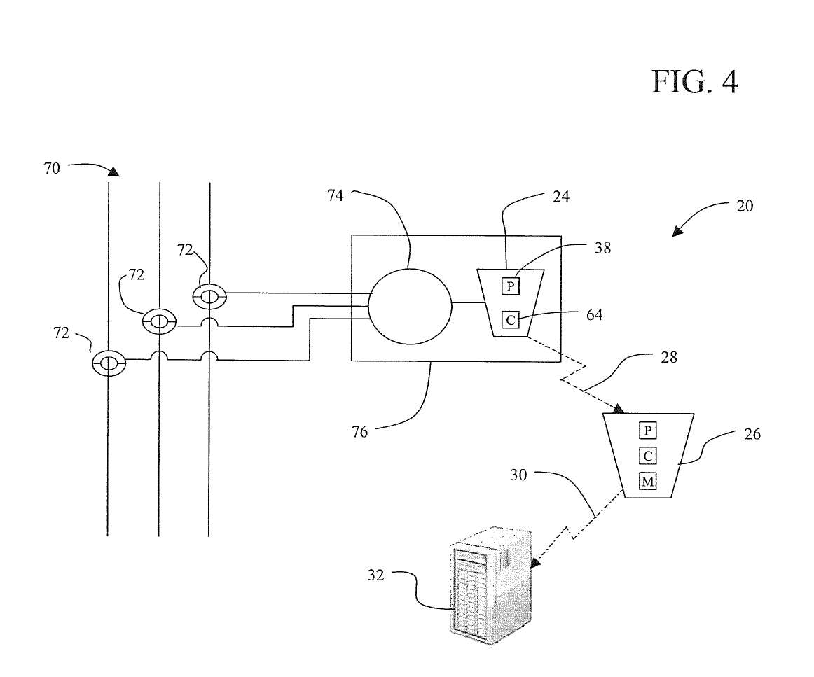

Referring now to FIG. 4, one embodiment of the system 20 for monitoring data through an electrical power system 70 is illustrated. The electrical power system 70 may be any electrical power system or network where sensors 22, such as but not limited to current transformers 72 may be used to detect parameters that effect performance or reliability of the electrical system. As such, the electrical power system 70 may be a high voltage transmission system, a low voltage distribution system, a secondary electrical system or a primary electrical system for example. The current transformers 72 may be positioned in any location where a utility for example desires to obtain information that will effect system 70 performance, such as adjacent an electrical feeder or between the network protector and the end customer for example.

The current transformers 72 are coupled to an electrical meter 74. In this embodiment, three current transformers 72 are provided with each measuring a different electrical phase of the power system 70. The electrical meter 74 may be any electrical meter known in the art that provides for the measurement of electrical power and provides an electronic output signal indicative of the measured power. In the exemplary embodiment, the meter 74 is an electronic meter having Advanced Metering Infrastructure (AMI) capabilities. In addition to an output signal of the measured electrical power, current or voltage, the meter 74 may also output other parameters, such as temperature or humidity for example.

The meter 74 is electrically connected to an interface device 24 such as through RS-232 port 44 for example. The communications between the meter 74 and the interface device 24 may include any data measured or recorded by the meter 74. The data may also include any calculated data that meter 74 derives from the measured or recorded data. As described above, the interface device 24 receives the data and either stores the data for future transmission to the coordinator device 26, or performs operation methods on the data to determine if the operational parameters of the electrical power system 70 are out of variance. Data is transmitted from the interface device 24 to the coordinator device 26 via the ad hoc personal area network 28. The coordinator device 26 in turn aggregates data from each of the individual interface devices 24 connected to the personal area network 28 and transmits either the aggregated data or individual data to the remote server 32. It should be appreciated that the monitoring system 20 provides advantages in the monitoring of electrical power. Often the points at which the utility wants to monitor the electrical power system 70 are located in a subterranean environment or in a utility cabinet where available space is low and the number of conductors, cables and wiring is high. By providing a wireless connection between the interface device 24 and the coordinator device 26, the installation costs are lowered and space requirements are lowered.

In the exemplary embodiment, the meter 74 and interface device 24 are installed in a sealed housing 76. It should be appreciated that when the monitoring system 20 is installed in some environments, such as a subterranean electrical vault for example, the level of moisture may be high and have a detrimental impact on the operation of the monitoring system 20. Therefore, in one embodiment, housing 76 is a National Electrical Manufacturers Association (“NEMA”) 6P rated enclosure. A NEMA 6P enclosure is constructed for either indoor or outdoor use to provide a degree of protection to degree of protection of the equipment inside the enclosure against ingress of solid foreign objects (falling dirt and the ingress of water (hose directed water and the entry of water during prolonged submersion at a limited depth). A NEMA 6P enclosure may also provide an additional level of protection against corrosion and prevent damage by the external formation of ice on the enclosure.

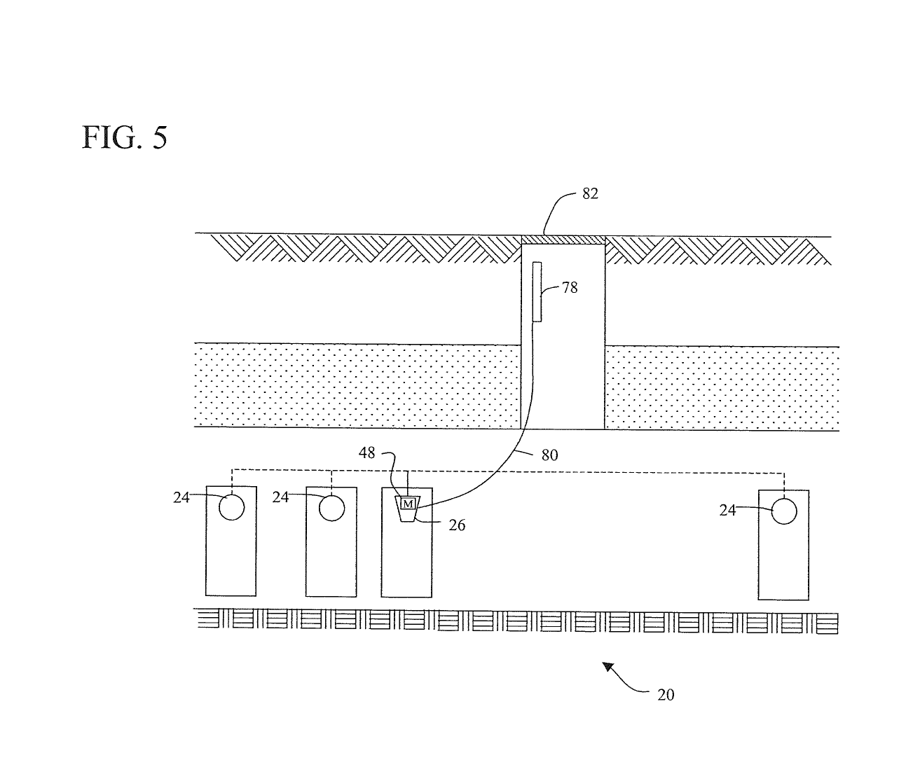

Another embodiment of the monitoring system 20 is illustrated in FIG. 5. In this embodiment, the sensors 22 are coupled to a utility service, such as branch circuits in an electrical power system for example, that are located in a subterranean environment. In this embodiment, an additional issue is created in the connection of the coordinator device 26 to the communications network 30. Since the coordinator device 26 is located below ground and often under a street for example, changes on the surface, such as the parking of an automobile or truck for example, may create interference in the connection of the coordinator device 26 to the communications network 30. To alleviate this issue, this embodiment includes an antenna 78 coupled to the modem 48 in coordinator device 26 by a cable 80. The antenna 78 is used to attenuate signals from the subterranean coordinator device 26. In one embodiment, the antenna 78 is positioned below a manhole cover 82 to allow service personnel access to maintenance. In the exemplary embodiment, the antenna 78 is a 3 dB gain antenna operating in the frequency range of 806-960 MHz. The antenna further includes features to provide for corrosion resistance and includes a phase coil to reduce wind noise.

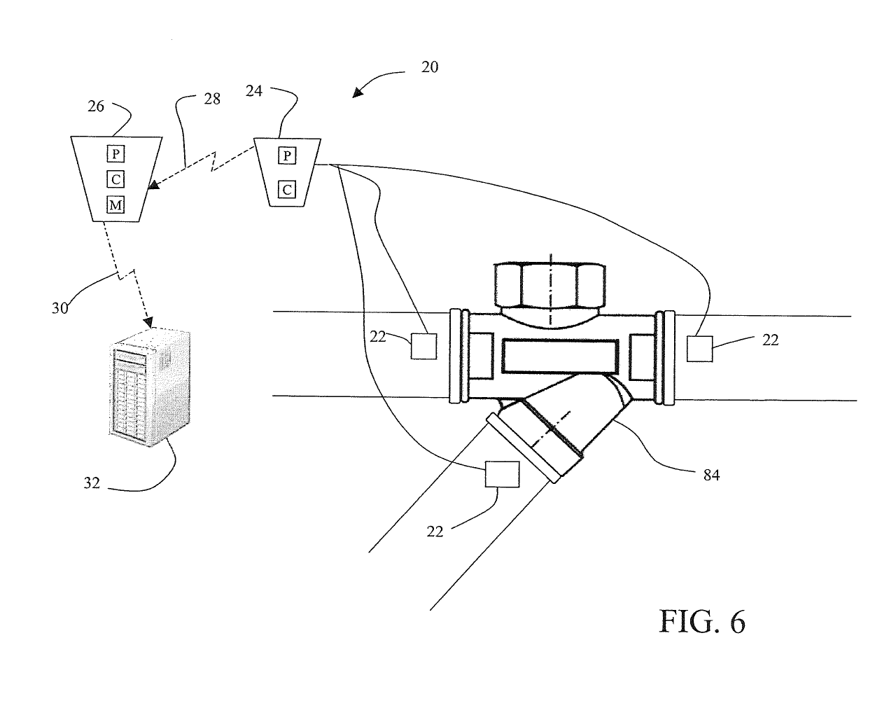

Another embodiment of the monitoring system 20 is illustrated in FIG. 6. In this embodiment, the interface device 24 is arranged to monitor a steam trap 84. A steam trap is a device used to discharge condensate and non-condensable gases while not permitting the escape of live steam. Steam traps are used in a variety of applications where steam is produced in one location and used in another. As such, steam traps may be used in process plants, electrical power production plants, building heating systems and district heating systems for example. One common type of steam trap is a disk-type steam trap. As steam enters the trap, the bimetal air vent ring is heated and expands, quickly slipping down to a valve seat skirt, freeing a disc. The steam flows rapidly under the released disc and the jet creates a low-pressure region. The steam jet flows into the pressure chamber creating a high-pressure region as the steam loses velocity and is compressed. This pressure pushes the disc valve down to close the valve seat.

When condensate enters the trap, the temperature in the pressure chamber drops, causing the steam to condense and the pressure to drop. If the pressure becomes lower than the inlet pressure, the disc valve opens to discharge condensate. Soon after the condensate is discharged, the valve closes. As such, the valve opens and closes automatically to intermittently discharge condensate that enters the trap. It should be appreciated that an operator may desire to monitor the operation of steam traps in their system since a failure of a steam trap may result in steam leaking out with the condensate or a build up of condensate in the system. Both of these situations reduce performance and create efficiency losses for the operator and thus increase costs.

There are a number of parameters in a steam trap that the operator may wish to monitor, such as but not limited to temperature, pressure and condensate level, or a combination of these parameters in different locations within the steam trap. In the embodiment illustrated in FIG. 6, the interface device 24 is coupled directly to sensors 22 that are mounted to steam trap 84. The sensors 22 may measure any of the aforementioned parameters. The interface device 24 receives signals from the sensors 22 via I/O controller 62. If necessary A/D converters 40 are used to transform the signal from an analog to a digital signal. As described above, the interface device 24 receives the signals and either stores the data in NVM device 58 and/or transmits the data via personal area network 28 to the coordinator device 26. Coordinator device 26 in turn aggregates the data from all of the interface devices 24 within the personal area network 28 and transmits data to remote server 32 via communications network 30.

It should be appreciated that while the embodiments described herein refer to coordinator devices 26 that are coupled to interface devices 24 which are coupled to sensors measuring similar types of processes, the scope of the claims should not be so limited. In some embodiments, the coordinator device 26 may be coupled to interface devices 24 that measure parameters from different processes or similar processes but different parameters. For example, the coordinator device 26 may have one interface device 24 on the personal area network 28 that measures electrical power system parameters, while another interface device 24 measures steam trap properties.

The monitoring system described herein provides a number of advantages in improving the cost efficient remote monitoring of a large number of devices. By providing a personal area network with a single coordinator, the number of devices transmitting data to a server is reduced. This in turn reduces the complexity of the data storage and analysis by the server and also reduces data traffic on the communications network. The monitoring system also reduces installation costs and opportunities for error in confined equipment cabinets having many conduits and cables. Further, where the monitoring system is installed in a subterranean environment, data may be collected wirelessly and then transmitted by a single device that is located adjacent an entrance to the surface. Where necessary, a single antenna may be used to further enhance the communications instead of multiple antennas. Finally, the monitoring network provides flexibility to the operator in allowing a mixed network of devices and processes to be monitored and data transmitted to a remote server as part of a single cohesive system.

An embodiment of the invention may be embodied in the form of computer-implemented processes and apparatuses for practicing those processes. Embodiments of the present invention may also be embodied in the form of a computer program product having computer program code containing instructions embodied in tangible media, such as floppy diskettes, CD-ROMs, hard drives, USB (universal serial bus) drives, or any other computer readable storage medium, such as random access memory (RAM), read only memory (ROM), or erasable programmable read only memory (EPROM), for example, wherein, when the computer program code is loaded into and executed by a computer, the computer becomes an apparatus for practicing the invention. The embodiments of the invention may also be embodied in the form of computer program code, for example, whether stored in a storage medium, loaded into and/or executed by a computer, or transmitted over some transmission medium, such as over electrical wiring or cabling, through fiber optics, or via electromagnetic radiation, wherein when the computer program code is loaded into and executed by a computer, the computer becomes an apparatus for practicing the invention. When implemented on a general-purpose microprocessor, the computer program code segments configure the microprocessor to create specific logic circuits. One technical effect of the executable instructions is to monitor a process or device parameter and transmit the data via a personal area network to a coordinator device. The coordinator device aggregates the data and transmits the information to a remote server.

While the invention has been described with reference to exemplary embodiments, it will be understood that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best or only mode contemplated for carrying out this invention, but that the invention will include all embodiments falling within the scope of the appended claims. Also, in the drawings and the description, there have been disclosed exemplary embodiments of the invention and, although specific terms may have been employed, they are unless otherwise stated used in a generic and descriptive sense only and not for purposes of limitation, the scope of the invention therefore not being so limited. Moreover, the use of the terms first, second, etc. do not denote any order or importance, but rather the terms first, second, etc. are used to distinguish one element from another. Furthermore, the use of the terms a, an, etc. do not denote a limitation of quantity, but rather denote the presence of at least one of the referenced item.

What is claimed is:

1. A monitoring system for measurement of parameters, said monitoring system comprising:
a first sensor positioned in a subterranean environment;
a first interface directly coupled to said first sensor, said first interface adapted to wirelessly transmit a first input signal in response to receiving a signal from said first sensor;
a second sensor positioned in said subterranean environment at a geographically distant position from said first sensor;
a second interface directly coupled to said second sensor, said second sensor adapted to wirelessly transmit a second input signal in response to receiving a signal from said second sensor;
a third interface coupled for wirelessly communicating with said first interface and said second interface, wherein said first interface, said second interface and said third interface form a wireless personal area network; and,
a communications device directly coupled to said third interface, said communications device adapted to transmit an output signal to a remote server in response to said third interface receiving said first input signal or said second input signal.

2. The monitoring system of claim 1 wherein said first interface, said second interface and said third interface are identical.

3. The monitoring system of claim 2 further comprising an antenna directly coupled to said communications device, wherein said antenna is positioned adjacent a ground surface level.

4. The monitoring system of claim 2 wherein said first sensor and said second sensor are thermocouples coupled to a steam trap.

5. The monitoring system of claim 2 wherein said first sensor and said second sensor are current transformers coupled to an electrical power system.

6. A monitoring system for subterranean devices, said monitoring system comprising:
a first sensor adapted to sense a presence and quantity of a first parameter associated with said subterranean devices;
an interface in communication with said first sensor, said interface adapted to convert sensor signals received from said first sensor into a first output signal;
a coordinator in wireless communication with said interface, said coordinator adapted to transmit a second output signal through a communications network in response to receiving said first output signal, said communications network being arranged partially in a subterranean environment; and,
a remote server coupled for communication to said coordinator by said communications network, wherein said remote server is adapted to receive and store said second output signal.

7. The monitoring system of claim 6 further comprising
a second sensor adapted to sense a presence and quantity of a second parameter associated with said subterranean device;
wherein said interface is in communication with said second sensor, said interface adapted to convert sensor signals from said second sensor into a second output signal;
wherein said coordinator is adapted to convert said first output signal and said second output signal into a third output signal.

8. The monitoring system of claim 7 wherein said interface and said coordinator form a wireless mesh network.

9. The monitoring system of claim 8 wherein said subterranean device is a steam trap and said first sensor is a thermocouple and said second sensor is a level sensor.

10. The monitoring system of claim 8 wherein said subterranean device is an electrical cable in an electrical power system and said first sensor is a current transformer and said second sensor is a temperature sensor.

11. The monitoring system of claim 10 wherein said interface includes an electrical meter and a communications device, wherein said electrical meter is electrically coupled between said communications device and said first sensor.

12. The monitoring system of claim 11 further comprising a sealed enclosure, wherein said subterranean devices, said first sensor, said second sensor and said interface are positioned within a sealed housing.

13. The monitoring system of claim 11 wherein said communications device includes an antenna mounted close to a ground level surface.

14. A monitoring system for a subterranean utility system, said monitoring system comprising:
a first plurality of subterranean sensors, each of said first plurality of subterranean sensors adapted to monitor parameters associated with said subterranean utility system;
a first plurality of subterranean interfaces, each of said first plurality of subterranean interfaces being associated with one of said first plurality of subterranean sensors, wherein each of said first plurality of subterranean interfaces includes a first processor that hosts a web server configured to transmit a first input signal in response to receiving a signal from one of said first plurality of subterranean sensors associated with said first processor; and,
a first subterranean coordinator wirelessly coupled for communication to said web servers associated with said first plurality of subterranean interfaces, said first subterranean coordinator being adapted to receive first input signals from said web servers and transmit an first output signal in response to receiving said first input signal, wherein said first subterranean coordinator and said first plurality of subterranean sensors form a first personal area network.

15. The monitoring system of claim 14 further comprising a remote server wirelessly coupled for communication of said first output signal to said first subterranean coordinator.

16. The monitoring system of claim 15 wherein said first subterranean coordinator includes a second processor that hosts a web server, said first subterranean coordinator being adapted to allow said first subterranean coordinator web server to communicate with each of said first plurality of subterranean interfaces web servers and said remote server.

17. The monitoring system of claim 16 further comprising:
a second plurality of subterranean sensors, each of said second plurality of subterranean sensors adapted to monitor parameters associated with said subterranean utility system;
a second plurality of subterranean interfaces, each of second plurality of subterranean interfaces being associated with one of said second plurality of subterranean sensors, wherein each of said second plurality of subterranean interfaces includes a third processor that hosts a web server configured to transmit a second input signal in response to receiving a signal from one of said second plurality of subterranean sensors associated with said third processor; and,
a second coordinator wirelessly coupled for communication to said web servers associated with said second plurality of subterranean interfaces, said second coordinator being adapted to receive said second input signal from said second plurality of subterranean interfaces web servers and transmit as second output signal to said remote server in response to receiving said second input signal, wherein said second coordinator and said second plurality of subterranean interfaces form a second personal area network.

18. The monitoring system of claim 17 wherein said second output signal is transmitted to said remote server through said first subterranean coordinator.

19. The monitoring system of claim 18 wherein said first plurality of subterranean sensors and said second plurality of subterranean sensors are thermocouples.

20. The monitoring system of claim 18 wherein said first plurality of subterranean sensors and said second plurality of subterranean sensors are current transformers.
